(19) United States
(12) Patent Application Publication
(10) Pub. No.: US 2006/0294132 A1
(43) Pub. Date: Dec. 28, 2006

(54) SYSTEM AND METHOD FOR GENERATING A PLAY-LIST

(76) Inventors: Kuan-Hong Hsieh, Shenzhen (CN); Zai-An Pan, Shenzhen (CN); Xiao-Guang Li, Shenzhen (CN); Bing Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,708

(22) Filed: Apr. 24, 2006

(30) Foreign Application Priority Data
Jun. 24, 2005 (CN) 200510035531.5

(51) Int. Cl. G06F 7/00

(52) U.S. Cl. 707/102

(57) ABSTRACT

A method for automatically generating a play list based on the age of the media recording (based on released date) and the time period the media file was last played. This method uses tags on the media file to store the corresponding dates and generates a weight value on each media file by using an algorithm based on settable values for each elapsed time period of the released date and the last played date. The present invention makes the play-list more tailored to a user's listening preferences.

### FIELD OF THE INVENTION

The present invention relates to a system and method for generating a media play-list of media files, especially to elapsed days from a current date to corresponding dates related to the media files.

### DESCRIPTION OF RELATED ART

The continuous development of new digital technology has helped made digital devices such as digital audio, digital picture, and other digital medias become popular among people. Media can be stored digitally in various data storage medium such as a hard disk, a compact disc (CD), and a network server. These data storage medium can then be used with portable devices such as a personal digital assistant (PDA), a media player, and/or an electronic-book reader (e-book). A current standard CD can store up to 140 average sized MPEG layer three (MP3) media files, whereas a media player with a data storage medium of 10 Gigabytes can store up to 2000 MP3 files. The cost of data storage medium has continued to decrease, allowing the average person to more easily acquire more data storage capacity. Currently, a personal computer has a standard data storage capacity of 80 Gigabytes that can easily store up to 160,000 pieces of average sized MP3 files. As users continuously acquire their favorite media files, it is important that users can also quickly identify and select a desired media file from a humongous pool of stored files.

Most media players currently have an option to group and select media files by the media file's tag contents. Usually, the media file's title, artist, album, and genre identity are stored by the tags to allow media players to automatically search and categorize the files. A media file management program further allows users to select a combination of media files into a play-list file. The saved play-list is essentially a list of shortcuts (pointer to the directory path) of the media files stored within, and can be used by the media player instead of manually searching and selecting every desired media files each time the media player is executed. Each play-list can then be categorically stored by name. However, users are still required to remember the directory path where each play-list is stored. As a user creates more and more play-lists, remembering a desired play-list may not be easy, furthermore, skipping over an unwanted media file while playing a play-list still has to be done manually.

In order to solve the problems mentioned, there is a method available in the market in selecting favorite media files to generate a play-list. For example, U.S. Pat. No. 6,987,221 issued on Jan. 17, 2006 and entitled “AUTO PLAYLIST GENERATION WITH MULTIPLE SEED SONGS” provides a method for generating a play-list automatically. The method includes steps of: selecting one or more feed media files, the feed media files include desired media files and undesired media files; wherein the user can set a weight on each seed media file representing the importance level of each seed media file. Afterwards, the method compares each media file with each seed media file such that a media file can be analyzed and identified into a user defined preferred play-list. The play-list further allows manual edits by the user.

However, the above mentioned method requires manual inputs on the weight attributes on multiple seed files before the method can run comparison tests on each media files. These manual operations may be annoying and time consuming with no guarantee that the resulting selected media files would be tailored to a user's listening preferences.

Therefore, a heretofore unaddressed need exists in the industry to overcome the aforementioned deficiencies and inadequacies.

### SUMMARY OF INVENTION

In order to solve said problems, the present invention provides a method and system for setting a weight value on each media file according to related date of the media file, and then generating a play-list according to weight values of the media files. The present invention makes the play-list more suitable to the user's listening preferences.

The method for generating a play-list of media files, each of the media files includes a tag for holding relative information about the media files. The method includes the steps of: setting one or more date fields in the tag for respectively storing relative date information of the media file; setting one or more weight tables for storing elapsed days from a current date to the corresponding dates and corresponding weight values; updating the last played date in a corresponding date field of each media file once the media files are played; receiving a control command for generating a play-list; obtaining corresponding dates from the corresponding date fields of each media file in response to the control command; calculating elapsed days from a current date to the corresponding dates; obtaining corresponding weight values from the weight tables corresponding to the elapsed days; calculating a final weight value based on the obtained weight values; and generating the play-list of the media files according to the final weight values thereof.

The system for generating a play-list of media files, each of the media files includes a tag for holding relative information about the media files. The system includes a data storage unit, an input unit, a control unit and a file management unit. The data storage unit stores the media files and one or more weight tables. The tag of each media file includes one or more date fields in the tag for storing relative date information of the media file. The weight tables store elapsed days from a current date to the corresponding dates and corresponding weight values. The input unit generates commands in response to operations of a user. The control unit identifies the commands and executes corresponding control commands. The control commands include a play-list generation control command. The file management unit, under the control of the control unit, updates the last played date of each media file in course of the media files being played, receives the play-list generation control command; obtains corresponding dates from the date fields of each media file in response to the play-list generation control command, calculates elapsed days from a current date to the corresponding dates, obtains corresponding weight values from the weight tables according to the elapsed days, calculates a final weight value based on the obtained weight values, and generates the play-list of the media files according to the final weight values thereof.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a schematic diagram of an user interface of an media player such as a MP3 player in accordance with a preferred embodiment of the present invention;

FIG. 2 is a block diagram hardware infrastructure of the media player of FIG. 1;

FIG. 3A is a flowchart of a preferred method for generating a play-list in the media player of FIG. 2;

FIG. 3B is a flowchart of a preferred method for playing the media files listed on the play-list and updating the last played date in the last played date field thereof;

FIG. 4 is a schematic diagram representing a relationship between elapsed weeks and a weight value; and

FIG. 5 is a schematic diagram representing a relationship between elapsed days and a weight value.

### DETAILED DESCRIPTION

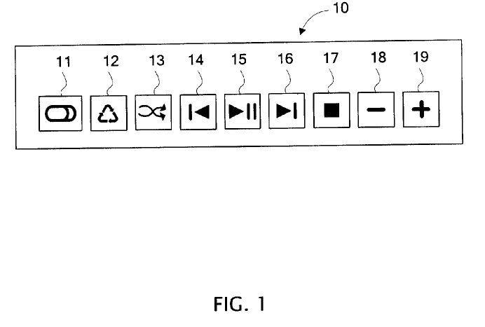

FIG. 1 is a schematic diagram of an user interface of a media player such as a MP3 player in accordance with a preferred embodiment of the present invention. The media player 10 is user-controllable to skip forward (e.g., to next item), play a media file, pause a playing media file, skip backward (e.g., to previous item), activate/deactivate the media player, adjust the volume output of the media player, and the like. Accordingly, the media player 10 provides a user interface for selecting these functions. The user interface sets a plurality of buttons thereon, such as a skip forward button 14, a play/pause button 15, a skip backward button 16, a stop/power button 17, a decrease volume button 18, and an increase volume button 19. The user interface further sets a play in order button 12 for playing selected media files in a predefined sequential order, and a random play button 13 for playing the media files randomly. Moreover, the user interface includes a locked button 11 for locking the buttons 12 to 19, thereby disabling the buttons functions therewith.

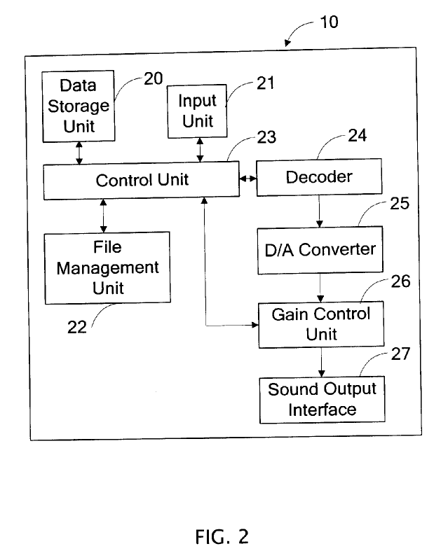

FIG. 2 is a block diagram hardware infrastructure of the media player of FIG. 1. The media player 10 includes a data storage unit 20, an input unit 21, a file management unit 22, a control unit 23, a decoder 24, a digital/analog converter 25, a gain control unit 26, and a sound output interface 27. The data storage unit 20 stores a plurality of media files, a first weight table, a second weight table, a default play-list, and one or more favorite index tables for indicating favorite media files of a user. Each of the media files is composed of a plurality of frames; a frame can be viewed as a small segment of the media file. Furthermore, each media file includes a tag for holding relative information of the media file. The relative information includes a released date, a last played date, and so on. Accordingly, the tag includes a released date field, a last played date field, etc., to store the corresponding information. The released date is a date on which the recording of the media file is released to public, and the last played date is a date on which the media file is recently played. In addition, the data storage unit 20 can be a flash storage, a hard disk driver, and the like.

The input unit 21 includes a plurality of buttons (i.e., 11 to 19), thereby forming the user interface of a preferred media player (as shown in FIG. 1) to generate commands in response to operational inputs. The control unit 23 identifies the commands from the input unit 21, and issues corresponding control commands to control the data storage unit 20, the file management unit 22, and the like. The control commands include a control command for generating a play-list, namely a play-list generation control command.

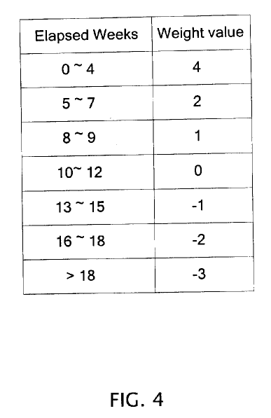

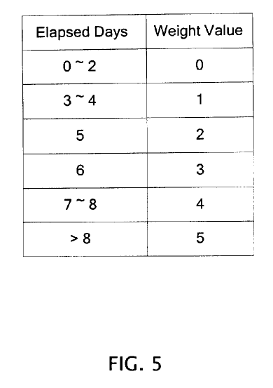

When a control command is issued by the control unit 23, the file management unit 22 obtains the released date of each media file from the released date field thereof, and calculates elapsed weeks from the released date to a current date, the elapsed weeks indicate weeks from a current date to the released date; obtains the last played date of each media file from the last played date field, and calculates elapsed days from the last played date to the current date, the elapsed days indicate an amount of days from the current date to the last played date; obtains a corresponding weight value from a first weight table (described more fully in FIG. 4 below) according to the elapsed weeks, and obtains the other corresponding weight value from a second weight table (described more fully in FIG. 5 below) according to the elapsed days, the weight value would indicate the user's preference level on a given media file.

The file management unit 22 calculates a final weight value based on the obtained weight values from the two weight tables; stores the final weight value of each media file in a temporary file, generates a play-list of the media files according to the final weight values thereof; stores the play-list in the data storage unit 20; plays the media files listed on the play-list; and updates the last played date in the last played date field of each media file once the frames thereof have been played reach a predetermined value. In addition, the media files listed on the play-list may be from media files stored in the data storage unit 20, or may be from favorite media files indicated in the index table stored in the data storage unit 20.

The decoder 24 decodes the media file from a coded digital format into a readable digital format to be played. The digital/analog converter 25 converts the decoded digital media file to analog media signals. The gain control unit 26 amplifies the analog media signals under the control of the control unit 23. The sound output interface 27 outputs the amplified analog media signals to an earphone or a speaker (not shown).

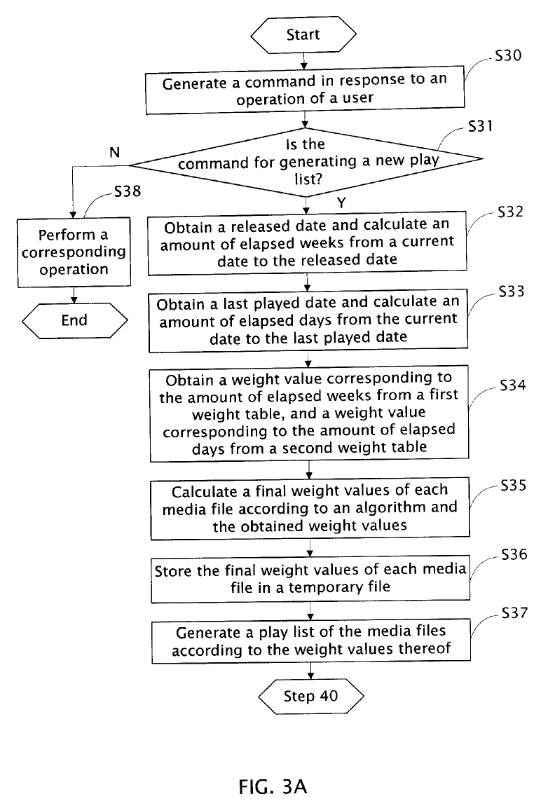

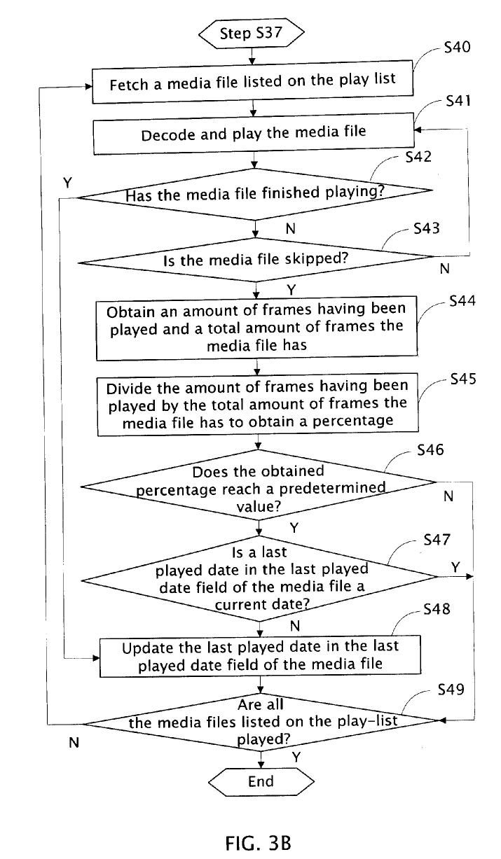

FIG. 3A is a flowchart of a preferred method for generating a play-list in the media player of FIG. 2. In a power-off state of the medial player 10, a user selects the stop/power button 17 to activate the media player 10. In step S30, the input unit 21 generates a command in response to an input selection of the user, and sends the command to the control unit 23. In step S31, the control unit 23 determines whether the command is for updating a default play-list, namely generating a new play-list. If the command is not for generating a new play-list, in step S38, the control unit 23 controls a corresponding unit to perform a corresponding operation according to the command, and the procedure is finished.

If the command is for generating a new play-list, in step S32, the file management unit 22 obtains a released date and a last played date of each media file from the tag thereof. In step S33, the file management unit 22 calculates elapsed weeks from the released date to a current date, and obtains a corresponding weight value from the first weight table according to the elapsed weeks. In step S34, the file management unit 22 calculates elapsed days from the last played date to the current date, and obtains the other corresponding weight value from the second weight table according to the elapsed days. In step S35, the file management unit 22 calculates a final weight value of each media file according to an algorithm and the obtained weight values. In step S36, the file management unit 22 stores the final weight values of each media file in a temporary file in the data storage unit 20.

In step S37, the file management unit 22 generates a play-list of the media files according to the final weight values thereof. For example, the file management unit 22 rearranges all the media files stored in the data storage unit 20 according to the final weight values, thereby generating the play-list therefrom. That is, the file management unit 22 orderly rearranges the media files according to the final weight values, or calls a random function, which employs the final weight values of the media files as a parameter, to randomly rearrange the media files. I.e., the media files having the greater final weight values would be more possible to be listed in the beginning portion of the play-list.

Furthermore, the file management unit 22 may also directly select a plurality of media files each of which has a weight value being greater than a predetermined value, thereby generating another play-list therefrom. The file management unit 22 may also rearrange all the media files based on the weight values in descending order, and then selects a predetermined amount of media files on the top of the ordered list, thereby generating another play-list therefrom.

FIG. 3B is a flowchart of a preferred method for playing the media files listed on the play-list and updating the last played date in the last played date field thereof. In step S40, the file management unit 22 fetches a media file listed on the play-list. In step S41, The decoder 24 decodes the media file from a coded digital form to a decoded digital form; the digital/analog converter 25 converts the decoded digital media file to analog media signals; the sound output interface27 amplifies and outputs the analog media signals to an earphone or a speaker (not shown). In step S42, the file management unit 22 determines whether the media file has finished playing. If the media file has finished playing, the procedure goes to step S47. If the media file has not finished playing, in step S43, the file management unit 22 determines whether the media file is skipped via the control unit 23. If the media file is not skipped, the procedure goes to step S41. If the media file is skipped, in step S44, the file management unit 22 obtains an amount of frames having been played and a total amount of frames the media file has. In step S45, the file management unit 22 divides the amount of frames having been played by the total amount of frames the media file has to obtain a percentage.

In step S46, the file management unit 22 determines whether the obtained percentage reaches a predetermined value. If the calculated percentage is less than the predetermined value, the file management unit 22 maintains the last played date of the media file as the same as that of before playing, and the procedure goes to step S49. If the calculated percentage reaches the predetermined value, in step S47, the file management unit 22 determines whether the last played date of the media file is the current date. If the last played date of the media file is the current date, the procedure goes to step S49. If the last played date of the media file is not the current date, the file management unit 22 updates the last played date in the last played date field of the media file to the current date. In step S49, the file management unit 22 determines whether all the media files listed on the play-list are played. If all the media files are played, the procedure is finished; if any one of the media files listed on the play-list is not played, the procedure goes to step S40 to fetch a next media file to play. During the course of a media file being played, if the file management unit 22 has received a stop command via the control unit 23, then stops playing the media file.

FIG. 4 is a schematic diagram representing a relationship between elapsed weeks and a weight value. For simplicity, in such case, when the elapsed weeks are between 0 and 4, the corresponding weight value is 4; when the elapsed weeks are between 5 and 7, the corresponding weight value is 2; when the elapsed weeks are between 8 and 9, the corresponding weight value is 1; when the elapsed weeks are between 10 and 12, the corresponding weight value is 0; when the elapsed weeks are between 13 and 15, the corresponding weight value is −1; when the elapsed weeks are between 16 and 18, the corresponding weight value is -2; when the elapsed weeks exceed 18, corresponding weight value is -3. However, the relationship between the elapsed weeks and the weight value may vary. That is, the relationship between the elapsed weeks and the weight value can be set and adjusted.

FIG. 5 is a schematic diagram representing a relationship between elapsed days and a weight value. For simplicity, in such case, when the elapsed days are between 0 and 2, the corresponding weight value is 0; when the elapsed days are between 3 and 4, the corresponding weight value is 1; when the elapsed days are 5, the corresponding weight value is 2; when the elapsed days are 6, the corresponding weight value is 3; when the elapsed days are between 7 and 8, the corresponding weight value is 4; when the elapsed days exceed 8, corresponding weight value is 5. However, the relationship between the elapsed days and the weight value may vary. That is, the relationship between the elapsed days and the weight value can be set and adjusted.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A method for generating a play-list of media files, each of the media files comprising a tag for holding relative information about the media file, the method comprising the steps of:
setting one or more date fields in the tag for respectively storing a relative dates of the media file;
setting one or more weight tables for storing elapsed days from a current date to the corresponding dates indexed corresponding weight values;
updating the last played date in a corresponding date field of each media file during the course of the media files being played;
receiving a control command for generating a play-list;
obtaining the corresponding dates from the corresponding date fields of each media file in response to the control command;
respectively calculating the elapsed days from a current date to the corresponding dates;
respectively obtaining corresponding weight values from the weight tables corresponding to the elapsed days;
calculating a final weight value based on the obtained weight values; and
generating the play-list of the media files according to the final weight values thereof.

2. The method for generating a play-list according to claim 1, wherein the corresponding date fields further comprises a released date field for storing a released date, and a last played date field for storing a last played date.

3. The method for generating a play-list according to claim 2, wherein the weight tables comprises a first weight table storing elapsed days from a current date to the released date and indexed to weight values, and a second weight table storing elapsed days from the current date to the last played date and indexed to weight values.

4. The method for generating a play-list according to claim 2, further comprising steps of: calculating the elapsed days from a current date to the released date, and calculating the elapsed days from the current date to the last played date.

5. The method for generating a play-list according to claim 1, wherein the step of generating the play-list of the media files further comprises: rearranging all the media files according to the weight values, thereby generating the play-list therefrom.

6. The method for generating a play-list according to claim 1, wherein the step of generating the play-list of the media files further comprises: selecting one or more media files each of which has a weight value being greater than a predetermined value, thereby generating the play-list therefrom.

7. The method for generating a play-list according to claim 1, wherein the step of generating the play-list of the media files further comprises: rearranging all the media files based on the weight values in descending order, selecting a predetermined amount of media files on the top of the ordered list, thereby generating another play-list therefrom.

8. A system for generating a play-list of media files, each of the media files comprising
a tag for holding relative information about the media files, the system comprising:
a data storage unit, for storing the media files and one or more weight tables, wherein the tag of each media file comprises one or more date fields in the tag for storing relative dates of the media file, and the weight tables store the elapsed days from a current date indexed to the corresponding dates and corresponding weight values;
an input unit for generating commands in response to operations of a user;
a control unit for identifying the commands and issuing corresponding control commands, wherein the control commands comprise a play-list generation control command; and
a file management unit, under the control of the control unit, being used for updating the last played date of each media file in course of the media files being played, receiving the play-list generation control command; obtaining dates from the corresponding date fields of each media file in response to the play-list generation control command, calculating the elapsed days from a current date to the corresponding dates, obtaining corresponding weight values from the weight tables according to the elapsed days, calculating a final weight value based on the obtained weight values, and generating the play-list of the media files according to the final weight values thereof.

9. The system for generating a play-list according to claim 8, wherein the corresponding date fields further comprises a released date field for storing a released date, and a last played date field for storing a last played date.

10. The system for generating a play-list according to claim 9, wherein the weight tables comprises a first weight table storing elapsed days from a current date to the released date and corresponding weight values; and a second weight table storing elapsed days from the current date to the last played date and corresponding weight values.

11. The system for generating a play-list according to claim 9, wherein the file management unit further calculates the elapsed days from the current date to the released date; and the elapsed days from the current date to the last played date.

12. The system for generating a play-list according to claim 8, wherein the file management unit further rearranges all the media files stored in the data storage unit according to the weight values, thereby generating the play-list therefrom.

13. The system for generating a play-list according to claim 8, wherein the file management unit further selects one or more media files each of which has a weight value being greater than a predetermined value, thereby generating the play-list therefrom.

14. The system for generating a play-list according to claim 8, wherein the file management unit further rearranges all the media files based on the weight values in descending order, selects a predetermined amount of media files on the top of the ordered list, thereby generates another play-list therefrom.
